(19) United States
(12) Patent Application Publication
(10) Pub. No.: US 2008/0268266 A1
(43) Pub. Date: Oct. 30, 2008

(54) Polyimide Metal Laminate and Suspension for Hard Disk Using Same

(75) Inventors: Koji Hirota, Kanagawa (JP); Naoki Nakazawa, Aichi (JP)

Correspondence Address: BUCHANAN, INGERSOLL & ROONEY PC, POST OFFICE BOX 1404, ALEXANDRIA, VA, 22313-1404, US

(73) Assignee: Mitsui Chemicals, Inc., Tokyo (JP)

(21) Appl. No.: 11/792,230

(22) PCT Filed: Dec. 1, 2005
(86) PCT No.: PCT/JP2005/022110

§ 371 Date: Feb. 6, 2008

(30) Foreign Application Priority Data
Dec. 3, 2004 (JP) 2004-350958

(51) Int. Cl. B32B 15/08

(52) U.S. Cl. 428/458

(57) ABSTRACT

A polyimide metal laminate including a polyimide resin having a copper foil and a stainless steel foil formed on respective sides of the polyimide resin, or a polyimide resin having two stainless steel foils formed on both sides of the polyimide resin, the polyimide metal laminate having: a peel strength of 1.0 kN/m or more between the polyimide resin and the stainless steel foil or copper foil; a peel strength of 1.0 kN/m or more between the polyimide resin and the stainless steel foil or copper foil after the polyimide metal laminate has been subjected to a heat treatment at 350° C. for 60 minutes; and no expansion or deformation after the polyimide metal laminate has been subjected to the heat treatment at 350° C. for 60 minutes.

### FIELD OF THE INVENTION

The present invention relates to a polyimide metal laminate that is widely used in applications such as a flexible wiring board and a wireless suspension for hard disk drives, and to a suspension for hard disk drives using the polyimide metal laminate.

More specifically, the present invention relates to a polyimide metal laminate that is suitable for a high density wiring board material capable of assembling parts at high temperature and fine pattern processing, because of favorable heat resistance of polyimide and less change in properties after heat treatment, and to a suspension for hard disk drives using the polyimide metal laminate.

### BACKGROUND ART

Nowadays, with the advancement of high density and high speed in hard disk drives, a so-called wireless suspension, i.e., a suspension on which a copper wiring is directly formed, is mainly used as a suspension for hard disk drives. As a material for the wireless suspension, a polyimide metal laminate made of the composite of copper alloy/polyimide/SUS304 is widely used.

As a method of manufacturing the wireless suspension using the polyimide metal laminate, for example, Patent Document 1 proposes a manufacturing method of a suspension in which a copper alloy layer and a SUS layer are subjected to a predetermined patterning, and then the polyimide layer is removed by plasma etching. Such a method using plasma etching has an advantage of allowing a free designing of a suspension, since a polyimide layer having a fine pattern can be etched easily and flying leads can be formed easily. However, since thermal properties of the polyimide layer and heat resistance of the polyimide metal laminate have not been taken into consideration, there have been problems such as deformation of the polyimide layer, peeling off of the copper wiring and the like, at the time of connecting the polyimide metal laminate to a substrate and/or components at high temperature, or curing a cover coating material needed to protect the copper wiring at high temperature.

Patent Document 2 discloses an attempt to remedy the aforementioned problems of heat resistance and thermal deformation by suppressing the linear moisture expansion coefficient of the polyimide layer in the range of 15×10⁻⁶/% RH or less. Although a certain level of achievement has been obtained in warping and dimensional stability against moisture by suppressing the linear moisture expansion coefficient low, no consideration has been made on the thermal stability of a highly heat expansive polyimide resin to be in contact with the metal. Therefore, sufficient effect has not been achieved in heat resistance as the polyimide metal laminate.

Patent Document 1: Japanese Patent Application Laid-Open No. H09-293222;

Patent Document 2: Published Japanese Translation of PCT International Publication No. 2001-531582.

### DISCLOSURE OF INVENTION

### Problems to be Solved by Invention

In view of the above-mentioned problems, an object of the present invention is to provide a polyimide metal laminate having excellent heat resistance by way of improving the heat resistance of the polyimide to be in contact with a metal and of reducing the change in properties of the polyimide metal laminate due to the change in temperature at the time of processing of the polyimide metal laminate, by minimizing the change in properties against heat treatment; and a suspension for hard disk drives using the polyimide metal laminate.

### Means for Solving the Problems

The present inventors have made an intensive study and found that the expansion and deformation of the polyimide metal laminate after heating can be suppressed by regulating the thermal properties of the polyimide in contact with a metal, and by using a polyimide having specified properties as the polyimide in contact with a stainless steel foil or copper foil when the polyimide is laminated to metal. Thus, the present invention has been completed based on these findings.

Namely, the present invention is

(1) A polyimide metal laminate comprising a polyimide resin having a copper foil and a stainless steel foil formed on respective sides of the polyimide resin, or a polyimide resin having two stainless steel foils formed on both sides of the polyimide resin, the polyimide metal laminate having:

a peel strength of 1.0 kN/m or more between the polyimide resin and the stainless steel foil or copper foil;

a peel strength of 1.0 kN/m or more between the polyimide resin and the stainless steel foil or copper foil after the polyimide metal laminate has been subjected to a heat treatment at 350° C. for 60 minutes; and

no deformation after the polyimide metal laminate has been subjected to the heat treatment at 350° C. for 60 minutes; and preferably

(2) The polyimide metal laminate according to (1), wherein the polyimide resin in contact with the stainless steel foil or copper foil has a glass transition temperature of 180° C. or higher; a storage elastic modulus at 300° C. of from 1×10⁷ Pa to 1×10⁸ Pa; and a storage elastic modulus at 350° C. of from 2×10⁷ Pa to 2×10⁸ Pa; and more preferably

(3) The polyimide metal laminate according to (1), wherein

the polyimide resin in contact with the stainless steel foil or copper foil is a polyimide obtained by reacting a diamine and a tetracarboxylic dianhydride,

the tetracarboxylic dianhydride used for the reaction being a combination of 3,3′,4,4′-benzophenone tetracarboxylic dianhydride and at least one tetracarboxylic dianhydride selected from pyromellitic dianhydride and 3,3′4,4′-biphenyltetracarboxylic dianhydride,

the amount of the 3,3′,4,4′-benzophenone tetracarboxylic dianhydride being 8 mol % or more and 20 mol % or less of a total amount of the tetracarboxylic dianhydrides used for the reaction, and wherein

the diamine used for the reaction contains at least one diamine selected from 1,3-bis(3-aminophenoxy) benzene, 4,4′-bis(3-aminophenoxy)biphenyl, 1,3-bis(3-(3-aminophenoxy)phenoxy)benzene, and 2,2-bis[4-(4-aminophenoxy)phenyl]propane; and further

(4) A suspension for hard disk drives, wherein the suspension is prepared from the polyimide metal laminate according to (1) to (3).

### EFFECT OF THE INVENTION

The present invention can provide a polyimide metal laminate suitably used as a high density wiring substrate material capable of assembling parts at high temperature and fine pattern processing because of favorable heat resistance and less change in properties after heat treatment, and also provide a suspension for hard disk drives that employs the polyimide metal laminate.

### BEST MODE FOR CARRYING OUT THE INVENTION

The polyimide metal laminate of the present invention and the method of manufacturing thereof will be described in detail below.

The polyimide metal laminate of the present invention is a polyimide resin layer having a stainless steel foil formed on both sides, or one side of the polyimide layer. The polyimide metal laminate has such a specific structure that a copper foil and a stainless steel foil are formed on respective sides of the polyimide resin, or two stainless steel foils are formed on both sides. Austenitic stainless steel such as SUS304, SUS301, and SUS305 may be used as the stainless steel foil. A stainless steel preferably has a spring property, since the polyimide metal laminate of the present invention is preferably used as a suspension material. SUS304 and SUS305 may be preferably used. More preferably, SUS304H-TA, a material obtained by subjecting SUS304 to a hardening treatment and further subjecting to tension annealing, may be used.

A copper foil may be used as the metal usable for the polyimide metal laminate of the present invention. Here, a copper alloy that contains copper as a main ingredient in an amount of 50 wt % or more of the total weight of the alloy is also included in a copper foil. Any kind of copper foils can be used no matter which type of electrodeposited copper foil or rolled copper foil the copper foil is. Any kind of copper alloy foils including a foil of C7025, an alloy with Ni, or HS1200, an alloy with Sn, and the like may be used. Since the polyimide metal laminate of the present invention is preferably used as a suspension material, a copper alloy foil having a spring property is preferably used. Preferable examples thereof include C7025 foil and B52 foil manufactured by Olin Brass Japan Inc.; NK120 foil manufactured by Nikko Materials Co., Ltd.; and EFTEC64-T foil manufactured by Furukawa Electric Co., Ltd.

Since the copper foil used for the polyimide metal laminate of the present invention is subjected to fine pattern processing and used for wiring in some cases, thinner copper foil is preferred for use in microscopic wiring. The thickness of the copper foil is preferably from 18 μm to 1 μm, and more preferably from 12 μm to 1 μm.

There is no limitation in particular on the thickness of the stainless steel foil used for the polyimide metal laminate. However, with the advancement of high density in hard disk drives (hereinafter, abbreviated as “HDD”), it has become necessary for the head to be positioned as close as possible to the hard disk. Therefore, flexibility has been required for the suspension material that supports the head, and the stainless steel foil is also requested to be thinner. Therefore, the thickness of from 20 μm to 10 μm is preferably used, and more preferably from 15 μm to 10 μm.

The polyimide resin layer of the polyimide metal laminate according to the present invention is required to have such heat resistance that no expansion or peeling off occurs in the polyimide resin and/or at the interface between the polyimide resin and a stainless steel foil or copper foil, i.e., no deformation occurs, when the polyimide metal laminate is heated in an oven at an atmospheric temperature of 350° C. for 60 minutes. It is preferable that no expansion or peeling off of 100 μm or more develops. The polyimide metal laminate of the present invention may be exposed to heating atmosphere at about 350° C. when processed into a flexible wiring board or a suspension and chips and sliders are assembled on the polyimide metal laminate. Therefore, it is desired that no expansion or peeling off develops. Further, in recent years, polyimide has been employed as a covering material for the polyimide metal laminate. The covering material of polyimide requires to be cured at a temperature of as high as 350° C., when the polyimide metal laminate is also exposed to high temperature for the curing. Also in this occasion, no expansion or others is expected to develop. There is no limitation on the atmosphere of an oven, but is preferably an atmosphere of an inert gas such as nitrogen or argon, to ensure the safety during the operation. The atmospheric temperature is the temperature at which the temperature of the polyimide metal laminate becomes 350° C., and the temperature in the oven need not necessarily be 350° C. It is desirable that no expansion or peeling off of 100 μm or more develops in the oven, during and/or after heating. The expansion or peeling off may develop either inside of the polyimide resin or at the interface between the polyimide resin and metal foil, and it is requested that no peeling off develops at any location. The size of the peeling off is preferably less than 100 μm, since there is no problem in appearance when the size is in this range, but is preferably less than 50 μm, and more preferably less than 0.1 μm.

The polyimide metal laminate of the present invention preferably has a peel strength of 1.0 kN/m or more between the polyimide resin and the stainless steel foil or copper foil, from the viewpoint of preventing the wiring from peeling off after processing of the polyimide metal laminate. In recent years, with the advancement of fine patterning, microscopic wiring with a line width of around 20 μm has been extensively performed. In order to improve the reliability for in this microscopic wiring, the peel strength between the polyimide resin and the stainless steel foil or copper foil is preferably as high as possible, and more preferably 1.2 kN/m or more. The peel strength is a value measured in accordance with IPC-TM650, TypeA Sec2.4.9, in the case of a wiring having a line width of 3.2 mm.

The polyimide resin layer of the polyimide metal laminate according to the present invention may be a layer of polyimide, polyamideimide, and the like, and preferably polyimide. The polyimide resin layer may be a structure of either single or multi layered, but preferably is two or three layered, because such a structure is easy to produce, and easy to regulate the properties thereof.

The polyimide resin in contact with the stainless steel foil or copper foil preferably has a glass transition temperature of preferably 180° C. or higher, more preferably from 180° C. to 300° C., and still more preferably from 200° C. to 270° C., from the viewpoint of securing favorable adhesion to these metals. The glass transition temperature can be measured by conventional methods.

It is essential to regulatet the viscoelastic behavior of the polyimide resin in contact with the stainless steel foil or copper foil at high temperature in the region of from 300° C. to 350° C., because the viscoelastic behavior has a great influence on the heat resistance of the polyimide metal laminate and the change in properties thereof after heating. For the evaluation of the viscoelastic behavior, a commercially available dynamic viscoelasticity measurement device can be used. For instance, DMA Q800 manufactured by TA Instrument Co., Ltd. and RSA-2 manufactured by Reometrics Co., Ltd. may be used for the measurement.

The behavior of the storage elastic modulus as measured with the dynamic elasticity measurement device in the above mentioned high temperature range particularly plays an important role in regulating of the heat resistance of the polyimide metal laminate and the change in properties thereof after heating. The storage elastic modulus at 300° C. is preferably smaller, because the polyimide is expected to have fluidity at high temperature so as to assure adhesion to a metal. However, when the storage elastic modulus at 300° C. is too small, there may be disadvantages, e.g., thermal deformation of the polyimide becomes too great when the polyimide is bonded to a metal. In addition, since polyimide has high water absorption property, expansion may develop in the polyimide by the action of the water absorbed in the polyimide, when the polyimide metal laminate containing water is heated. In order to prevent this expansion, the storage elastic modulus at high temperature of the polyimide is required to be kept above a certain level. Specifically, the polyimide is required to have a larger storage elastic modulus than the saturated water vapor pressure at 300° C.

In order to attain the above-mentioned effect, the polyimide in contact with a metal has a storage elastic modulus at 300° C. of preferably from 1×10⁷ Pa to 1×10⁸ Pa, and more preferably from 7×10⁷ Pa to 9×10⁷ Pa.

As an application of the polyimide metal laminate of the present invention, there may be mentioned a suspension for HDDs. On the suspension, a wiring circuit obtained by etching copper is formed. In recent years, a covering material containing polyimide as a main component has been used as a covering material that protects the wiring circuit, considering heat resistance and cleanliness. The polyimide cover material requires a curing process at high temperature of 350° C. or higher after the polyimide metal laminate has been coated with the polyimide cover material. Further, mounting of components such as ICs and piezo elements on the suspension has also become common, in which high temperature is also required due to the use of Pb-free solder. For these reasons, the heat resistance at 350° C. of the polyimide layer in contact with metal, i.e., the storage elastic modulus that directly affects the heat resistance, is also required to be regulated.

The storage elastic modulus at 350° C. is preferably higher than the saturated water vapor pressure at 350° C. in view of suppressing the expansion by heating, but is preferably lower considering the adhesion to a metal. When the storage elastic modulus of polyimide at 350° C. is high, the adhesion between the polyimide and metal after heating at 350° for 60 minutes is degraded and the peel strength between the polyimide and metal undesirably becomes lower than 1.0 kN/m. Specifically, the storage elastic modulus of polyimide at 350° C. is preferably from 2×10⁷ Pa to 2×10⁸ Pa, and more preferably from 3×10⁷ Pa to 1×10⁸ Pa. A polyimide resin that can satisfy these properties will be explained below.

Note that, the peel strength between the polyimide resin and the stainless steel foil or copper foil is preferably 1.0 kN/m or higher, and more preferably 1.5 kN/m or higher, after the polyimide metal laminate has been heat-treated at 350° C. for 60 minutes.

The polyimide resin in contact with the stainless steel foil or copper foil is preferably polyimide, which is obtained by reacting a diamine and a tetracarboxylic acid dianhydride. The tetracarboxylic acid dianhydride used for the reaction may be a combination of 3,3′,4,4′-benzophenone tetracarboxylic dianhydride and at least one tetracarboxylic dianhydride selected from pyromellitic dianhydride and 3,3′,4,4′-biphenyl tetracarboxylic dianhydride. In view of assuring the heat resistance of the polyimide, a certain ratio of the 3,3′,4,4′-benzophenone tetracarboxylic dianhydride, i.e., an acid dianhydride that undergoes an imine cross-linking reaction with an intra- or inter-molecular amino group, is preferably contained. However, when the above dianhydride is used, there is a problem that the heat resistance becomes too high, thereby excessively increasing the storage elastic modulus at high temperature of the polyimide. Therefore, the amount of the 3,3′,4,4′-benzophenone tetracarboxylic dianhydride is preferably 8 mol % or more and 20 mol % or less of the total amount of the tetracarboxylic dianhydrides used in the reaction, and more preferably 10 mol % or more and 15 mol % or less. Further, other optional acid dianhydrides may also be admixed as long as the properties of the thermoplastic polyimide are not impaired.

As the diamine used for the aforementioned thermoplastic polyimide, it is preferable to use at least one diamine selected from 1,3-bis(3-aminophenoxy)benzene, 4,4′-bis(3-aminophenoxy)biphenyl, 1,3-bis(3-(3-aminophenoxy)phenoxy)benzene, and 2,2-bis[4-(4-aminophenoxy)phenyl]propane. Other optional diamines may also be admixed as long as the properties of the polyimide are not impaired.

In the preparation of the aforementioned polyimide, the reaction mole ratio of diamine and tetracarboxylic dianhydride is preferably from 0.75 to 1.25, and more preferably from 0.90 to 1.10, since the reaction can be readily regulated and the heat fluidity of the obtained thermoplastic polyimide is favorable. As mentioned above, a polyimide resin prepared from the acid dianhydride and diamine selected from the specified range can satisfy the properties specified by the present invention.

The thickness of the polyimide is preferably from 0.5 μm to 50 μm, and more preferably from 1 μm to 10 μm, since by reducing the thickness of the polyimide, along with the thickness of the stainless steel foil or copper foil, downsizing and weight saving of electric instruments using the polyimide metal laminate can be achieved.

As the polyimide resin layer that does not directly contact the stainless steel foil or copper foil, preferable examples thereof other than the aforementioned thermoplastic polyimide resin include commercially available non-thermoplastic polyimide films such as “Apical™NPI” and “Apical™HP”, both available from Kaneka Corp., and “Kapton™EN” available from DuPont-Toray Co., Ltd. An optional polyimide that is obtained by reacting a diamine and a tetracarboxylic dianhydride may also be used as long as the properties of the polyimide metal laminate are not impaired.

Examples of the diamines usable for the polyimide preparation include, m-phenylenediamine, o-phenylenediamine, p-phenylenediamine, m-aminobenzylamine, p-aminobenzylamine, bis(3-aminophenyl)sulfide, (3-aminophenyl)(4-aminophenyl)sulfide, bis(4-aminophenyl)sulfide, bis(3-aminophenyl)sulfoxide, (3-aminophenyl)(4-aminophenyl)sulfoxide, bis(3-aminophenyl)sulfone, (3-aminophenyl)(4-aminophenyl)sulfone, bis(4-aminophenyl)sulfone, 3,3′-diaminobenzophenone, 3,4′-diaminobenzophenone, 4,4′-diaminobenzophenone, 3,3′-diaminodiphenylmethane, 3,4′-diaminodiphenylmethane, 4,4′-diaminodiphenylmethane, 4,4′-diaminodiphenyl ether, 3,3′-diaminodiphenyl ether, 3,4′-diaminodiphenyl ether, bis[4-(3-aminophenoxy)phenyl]methane, bis[4-(4-aminophenoxy)phenyl]methane, 1,1-bis[4-(3-aminophenoxy)phenyl]ethane, 1,1-bis[4-(4-aminophenoxy)phenyl]ethane, 1,2-bis[4-(3-aminophenoxy)phenyl]ethane, 1,2-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[3-(3-aminophenoxy)phenyl]-1,1,1,3,3,3-hexafluoropropane, 2,2-bis[4-(4-aminophenoxy)phenyl-1,1,1,3,3,3-hexafluoropropane, 1,3-bis(3-aminophenoxy)benzene, 1,4-bis(3-aminophenoxy)benzene, 1,4′-bis(4-aminophenoxy)benzene, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfoxide, bis[4-(aminophenoxy)phenyl]sulfoxide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 1,4-bis[4-(3-aminophenoxy)benzoyl]benzene, 1,3-bis[4-(3-aminophenoxy)benzoyl]benzene, 4,4′-bis[3-(4-aminophenoxy)benzoyl]diphenyl ether, 4,4′-bis[3-(3-aminophenoxy)benzoyl]diphenyle ther, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, bis[4-{4-(4-aminophenoxy)phenoxy}phenyl]sulfone, 1,4-bis[4-(4-aminophenoxy)-α,α-dimethylbenzyl]benzene, 1,3-bis[4-(4-aminophenoxy)-α,α-dimethylbenzyl]benzene, 1,3-bis(3-(4-aminophenoxy)phenoxy)benzene, 1,3-bis(3-(2-aminophenoxy)phenoxy)benzene, 1,3-bis(4-(2-aminophenoxy)phenoxy)benzene, 1,3-bis(2-(2-aminophenoxy)phenoxy)benzene, 1,3-bis(2-(3-aminophenoxy)phenoxy)benzene, 1,3-bis(2-(4-aminophenoxy)phenoxy)benzene, 1,4-bis(3-(3-aminophenoxy)phenoxy)benzene, 1,4-bis(3-(4-aminophenoxy)phenoxy)benzene, 1,4-bis(3-(2-aminophenoxy)phenoxy)benzene, 1,4-bis(4-(2-aminophenoxy)phenoxy)benzene, 1,4-bis(2-(2-aminophenoxy)phenoxy)benzene, 1,4-bis(2-(3-aminophenoxy)phenoxy)benzene, 1,4-bis(2-(4-aminophenoxy)phenoxy)benzene, 1,2-bis(3-(3-aminophenoxy)phenoxy)benzene, 1,2-bis(3-(4-aminophenoxy)phenoxy)benzene, 1,2-bis(3-(2-aminophenoxy)phenoxy)benzene, 1,2-bis(4-(4-aminophenoxy)phenoxy)benzene, 1,2-bis(4-(3-aminophenoxy)phenoxy)benzene, 1,2-bis(4-(2-aminophenoxy)phenoxy)benzene, 1,2-bis(2-(2-aminophenoxy)phenoxy)benzene, 1,2-bis(2-(3-aminophenoxy)phenoxy)benzene, 1,2-bis(2-(4-aminophenoxy)phenoxy)benzene, 1,3-bis(3-(3-aminophenoxy)phenoxy)-2-methylbenzene, 1,3-bis(3-(4-aminophenoxy)phenoxy)-4-methylbenzene, 1,3-bis(4-(3-aminophenoxy)phenoxy)-2-ethylbenzene, 1,3-bis(3-(2-aminophenoxy)phenoxy)-5-sec-butylbenzene, 1,3-bis(4-(3-aminophenoxy)phenoxy)-2,5-dimethylbenzene, 1,3-bis(4-(2-amino-6-methylphenoxy)phenoxy)benzene, 1,3-bis(2-(2-amino-6-ethylphenoxy)phenoxy)benzene, 1,3-bis(2-(3-aminophenoxy)-4-methylphenoxy)benzene, 1,3-bis(2-(4-aminophenoxy)-4-tert-butylphenoxy)benzene, 1,4-bis(3-(3-aminophenoxy)phenoxy)-2,5-di-tert-butylbenzene, 1,4-bis(3-(4-aminophenoxy)phenoxy)-2,3-dimethylbenzene, 1,4-bis(3-(2-amino-3-propylphenoxy)phenoxy)benzene, 1,2-bis(3-(3-aminophenoxy)phenoxy)-4-methylbenzene, 1,2-bis(3-(4-aminophenoxy)phenoxy)-3-n-butylbenzene, 1,2-bis(3-(2-amino-3-propylphenoxy)phenoxy)benzene, bis(3-aminopropyl)tetramethyl disiloxane, bis(10-aminodecamethylene)tetramethyl disiloxane, and bis(3-aminophenoxymethyl)tetramethyl disiloxane. These may be used alone or two or more kinds in combination.

Examples of the usable acid dianhydrides include pyromellitic dianhydride, 3-fluoropyromellitic dianhydride, 3,6-difluoropyromellitic dianhydride, 3,6-bis(trifluoromethyl)pyromellitic dianhydride, 1,2,3,4-benzene tetracarboxylic dianhydride, 2,2′,3,3′-benzophenone tetracarboxylic dianhydride, 3,3′,4,4′-biphenyltetracarboxylic dianhydride, 3,3″,4,4″-terphenyl tetracarboxylic dianhydride, 3,3″′,4,4″′-quaterphenyl tetracarboxylic dianhydride, 3,3″″,4,4″″-quinquephenyl tetracarboxylic dianhydride, 2,2′,3,3′-biphenyltetracarboxylic dianhydride, methylene-4,4′-diphthalic dianhydride, 1,1-ethynylidene-4,4′-diphthalic dianhydride, 2,2-propylidene-4,4′-diphthalic dianhydride, 1,2-ethylene-4,4′-diphthalic dianhydride, 1,3-trimethylene-4,4′-diphthalic dianhydride, 1,4-tetramethylene-4,4′-diphthalic dianhydride, 1,5-pentamethylene-4,4′-diphthalic dianhydride, 2,2-bis(3,4-dicarboxyphenyl)-1,1,1,3,3,3-hexafluoropropane dianhydride, difluoromethylene-4,4′-diphthalic dianhydride, 1,1,2,2-tetrafluoro-1,2-ethylene-4,4′-diphthalic dianhydride, 1,1,2,2,3,3-hexafluoro-1,3-trimethylene-4,4′-diphthalic dianhydride, 1,1,2,2,3,3,4,4-octafluoro-1,4-tetramethylene-4,4′-diphthalic dianhydride, 1,1,2,2,3,3,4,4,5,5-decafluoro-1,5-pentamethylene-4,4′-diphthalic dianhydride, oxy-4,4′-diphthalic dianhydride, thio-4,4′-diphthalic dianhydride, sulfonyl-4,4′-diphthalic dianhydride, 1,3-bis(3,4-dicarboxyphenyl)-1,1,3,3-tetramethylsiloxane dianhydride, 1,3-bis(3,4-dicarboxyphenyl)benzene dianhydride, 1,4-bis(3,4-dicarboxyphenyl)benzene dianhydride, 1,3-bis(3,4-dicarboxyphenoxy)benzene dianhydride, 1,4-bis(3,4-dicarboxyphenoxy)benzene dianhydride, 1,3-bis[2-(3,4-dicarboxyphenyl)-2-propyl]benzene dianhydride, 1,4-bis[2-(3,4-dicarboxylphenyl)-2-propyl]benzene dianhydride, bis[3-(3,4-dicarboxyphenoxy)phenyl]methane dianhydride, bis[4-(3,4-dicarboxyphenoxy)phenyl]methane dianhydride, 2,2-bis[3,(3,4-dicarboxyphenoxy)phenyl]propane dianhydride, 2,2-bis[4-(3,4-dicarboxyphenoxy)phenyl]propane dianhydride, 2,2-bis[3-(3,4-dicarboxyphenoxy)phenyl]-1,1,1,3,3,3-hexafluoropropane dianhydride, 2,2-bis[4-(3,4-dicarboxyphenoxy)phenyl]propane dianhydride, bis(3,4-dicarboxyphenoxy)dimethylsilane dianhydride, 1,3-bis(3,4-dicarboxyphenoxy)-1,1,3,3-tetramethyldisiloxane dianhydride, 2,3,6,7-naphthalene tetracarboxylic dianhydride, 1,2,5,6-naphthalene tetracarboxylic dianhydride, 3,4,9,10-perylene tetracarboxylic dianhydride, 2,3,6,7-anthracene tetracarboxylic dianhydride, 1,2,7,8-phenanthrene tetracarboxylic dianhydride, 1,2,3,4-butane tetracarboxylic dianhydride, 1,2,3,4-cyclobutane tetracarboxylic dianhydride, cyclopentane tetracarboxylic anhydride, cyclohexane-1,2,3,4-tetracarboxylic dianhydride, cyclohexane-1,2,4,5-tetracarboxylic dianhydride, 3,3′,4,4′-bicyclohexyltetracarboxylic dianhydride, carbonyl-4,4′-bis(cyclohexane-1,2-dicarboxylic) dianhydride, methylene-4,4′-bis(cyclohexane-1,2-dicarboxylic) dianhydride, 1,2-ethylene-4,4′-bis(cyclohexane-1,2-dicarboxylic) dianhydride, 1,1-ethynylidene-4,4′-bis(cyclohexane-1,2-dicarboxylic) dianhydride, 2,2-propylidene-4,4′-bis(cyclohexane-1,2-dicarboxylic) dianhydride, 1,1,1,3,3,3-hexafluoro-2,2-propylidene-4,4′-bis(cyclohexane-1,2-dicarboxylic)dianhydride, oxy-4,4′-bis(cyclohexane-1,2-dicarboxylic) dianhydride, thio-4,4′-bis(cyclohexane-1,2-dicarboxylic) dianhydride, sulfonyl-4,4′-bis(cyclohexane-1,2-dicarboxylic) dianhydride, 2,2′-difluoro-3,3′,4,4′-biphenyltetracarboxylic dianhydride, 5,5′-difluoro-3,3′,4,4′-biphenyltetracarboxylic dianhydride, 6,6′-difluoro-3,3′,4,4′-biphenyltetracarboxylic dianhydride, 2,2′,5,5′,6,6′-hexafluoro-3,3′,4,4′-biphenyltetracarboxylic dianhydride, 2,2′-bis(trifluoromethyl)-3,3′,4,4′-biphenyltetracarboxylic dianhydride, 5,5′-bis(trifluoromethyl)-3,3′,4,4′-biphenyltetracarboxylic dianhydride, 6,6′-bis(trifluoromethyl)-3,3′,4,4′-biphenyltetracarboxylic dianhydride, 2,2′,5,5′-tetrakis(trifluoromethyl)-3,3′,4,4′-biphenyltetracarboxylic dianhydride, 2,2′,6,6′-tetrakis(trifluoromethyl)-3,3′,4,4′-biphenyltetracarboxylic dianhydride, 5,5′,6,6′-tetrakis(trifluoromethyl)-3,3′,4,4′-biphenyltetracarboxylic dianhydride, 2,2′,5,5′,6,6′-hexakis(trifluoromethyl)-3,3′,4,4′-biphenyltetracarboxylic dianhydride, 3,3′-difluoroxy-4,4′-diphthalic dianhydride, 5,5′-difluoroxy-4,4′-diphthalic dianhydride, 6,6′-difluoroxy-4,4′-diphthalic dianhydride, 3,3′5,5′,6,6′-hexafluoroxy-4,4′-diphthalic dianhydride, 3,3′-bis(trifluoromethyl)oxy-4,4′-diphthalic dianhydride, 5,5′-bis(trifluoromethyl)oxy-4,4′-diphthalic dianhydride, 6,6′-bis(trifluoromethyl)oxy-4,4′-diphthalic dianhydride, 3,3′,5,5′-tetrakis(trifluoromethyl)oxy-4,4′-diphthalic dianhydride, 3,3′,6,6′-tetrakis(trifluoromethyl)oxy-4,4′-diphthalic dianhydride, 5,5′,6,6′-tetrakis(trifluoromethyl)oxy-4,4′-diphthalic dianhydride, 3,3′,5,5′,6,6′-hexakis(trifluoromethyl)oxy-4,4′-diphthalic dianhydride, 3,3′-difluorosulfonyl-4,4′-diphthalic dianhydride, 5,5′-difluorosulfonyl-4,4′-diphthalic dianhydride, 6,6′-difluorosulfonyl-4,4′-diphthalic dianhydride, 3,3′,5,5′,6,6′-hexafluorosulfonyl-4,4′-diphthalic dianhydride, 3,3′-bis(trifluoromethyl)sulfonyl-4,4′-diphthalic dianhydride, 5,5′-bis(trifluoromethyl)sulfonyl-4,4′-diphthalic dianhydride, 6,6′-bis(trifluoromethyl)sulfonyl-4,4′-diphthalic dianhydride, 3,3′,5,5′-tetrakis(trifluoromethyl)sulfonyl-4,4′-diphthalic dianhydride, 3,3′,6,6′-tetrakis(trifluoromethyl)sulfonyl-4,4′-diphthalic dianhydride, 5,5′,6,6′-tetrakis(trifluoromethyl)sulfonyl-4,4′-diphthalic dianhydride, 3,3′,5,5′,6,6′-hexakis(trifluoromethyl)sulfonyl-4,4′-diphthalic dianhydride, 3,3′-difluoro-2,2-perfluoropropylidene-4,4′-diphthalic dianhydride, 5,5′-difluoro-2,2-perfluoropropylidene-4,4′-diphthalic dianhydride, 6,6′-difluoro-2,2-perfluoropropylidene-4,4′-diphthalic dianhydride, 3,3′,5,5′,6,6′-hexafluoro-2,2-perfluoropropylidene-4,4′-diphthalic dianhydride, 3,3′-bis(trifluoromethyl)-2,2-perfluoropropylidene-4,4′-diphthalic dianhydride, 5,5′-bis(trifluoromethyl)-2,2-perfluoropropylidene-4,4′-diphthalic dianhydride, 6,6′-difluoro-2,2-perfluoropropylidene-4,4′-diphthalic dianhydride, 3,3′,5,5′-tetrakis(trifluoromethyl)-2,2-perfluoropropylidene-4,4′-diphthalic dianhydride, 3,3′,6,6′-tetrakis(trifluoromethyl)-2,2-perfluoropropylidene-4,4′-diphthalic dianhydride, 5,5′,6,6′-tetrakis(trifluoromethyl)-2,2-perfluoropropylidene-4,4′-diphthalic dianhydride, 3,3′,5,5′,6,6′-hexakis(trifluoromethyl)-2,2-perfluoropropylidene-4,4′-diphthalic dianhydride, 9-phenyl-9-(trifluoromethyl)xanthene-2,3,6,7-tetracarboxylic dianhydride, 9,9-bis(trifluoromethyl)xanthene-2,3,6,7-tetracarboxylic dianhydride, bicycle[2,2,2]oct-7-en-2,3,5,6-tetracarboxylic dianhydride, 9,9-bis[4-(3,4-dicarboxy)phenyl]fluorene dianhydride, and 9,9-bis[4-(2,3-dicarboxy)phenyl]fluorene dianhydride. These may be used alone or two or more kinds in combination.

The aforementioned polyimide resins are prepared generally by mixing the aforementioned tetracarboxylic dianhydride and diamine at a predetermined ratio in a solvent such as N-methylpyrrolidone (NMP), methylformamide (DMF), dimethylacetoamide (DMAc), dimethylsulfoxide (DMSO), dimethyl sulfate, sulfolane, butyrolactone, cresol, phenol, halogenated phenol, cyclohexane, dioxane, tetrahydrofuran, diglyme and triglyme; reacting the mixture at a temperature of from 0° C. to 100° C. to obtain a precursor solution of a polyimide resin; and further heat-treating the solution in a high temperature atmosphere of from 200° C. to 500° C. to imidize, thereby obtaining a polyimide resin.

The polyimide metal laminate of the present invention may be prepared by hot-pressing and bonding the polyimide resin and a metal foil. Hereinafter, a process of hot-pressing and bonding the polyimide resin and a metal foil is described. There is no limitation in particular on the process of hot-pressing and bonding, but it is desirable that prior to hot-pressing and bonding the polyimide resin and metal foil, the moisture absorptivity of the polyimide be lowered to 0.1% RH or less by drying. When the polyimide containing moisture and metal foil are hot-pressed and bonded, a polyimide metal laminate with moisture contained in the polymide is formed, and heat expansion may easily develop in the polyimide. When the moisture absorptivity is 0.1% RH or less, the heat expansion can be prevented and stable properties can be obtained.

There is no limitation in particular on the process of drying the polyimide prior to hot-pressing and bonding, but there may be mentioned a process of leaving the polyimide in an oven heated to 80° C. or more for a long period of time to dry, for instance, 10 hours or more. In addition, there may be mentioned another process of drying the polyimide with an IR heater or a heating roll. The moisture absorptivity may be measured by Karl Fisher's method or thermal gravimetry.

As a typical process of hot pressing and bonding, there may be mentioned the processes of hot pressing and/or heat lamination. In the process of hot pressing, the polyimide resin and metal foil are cut out in a predetermined size for a pressing machine, then superimposed and bonded together by hot pressing. The heating temperature is desirably in the range of from 150° C. to 600° C. The magnitude of the pressure is not limited, but preferably from 0.1 kg/cm² to 500 kg/cm². The pressing time is not particularly limited.

There is no limitation in particular on the process of heat lamination, but preferably is the process of holding the polyimide resin and metal foil between rolls and laminating together. Any roll of metal or rubber and the like may be used as the roll. Any material may be used for the roll, but steel or stainless steel is used for the metal roll. A roll having a surface plated with chromium is preferable. A rubber roll is preferably made of a metal roll having a heat resisting silicone rubber or fluoro-type rubber on the surface thereof. The lamination temperature is preferably in the range of from 100° C. to 300° C. As the heating method, conduction heating, radiation heating using far infrared rays and the like, induction heating, and the other heating methods may be employed.

Thermal annealing after the heat lamination is also preferably conducted. As a heating apparatus, conventional heating ovens, autoclaves and others may be used. The heating atmosphere may be selected from the air, inert gas such as nitrogen and argon, and others. In one heating process, the film of the polyimide metal laminate may be continuously heated. In another heating process, the film is left standing in a heating oven in a state of being rolled onto a core. Either heating process of the above may be preferably employed. As the heating method, conduction heating, radiation heating, and the combination of these may be preferably employed. The heating temperature is preferably in the range of from 200° C. to 600° C. The heating time is preferably in the range of from 0.05 minute to 5,000 minutes.

Furthermore, the polyimide metal laminate of the present invention may be prepared by coating a metal foil with a precursor varnish of the polyimide resin, then drying the coating. On the metal foil, a solution of a thermoplastic polyimide or a solution of a polyamic acid i.e., a precursor of the thermoplastic polyimide, (hereinafter, these solutions are generically called as a varnish) may be directly applied and dried so as to prepare the polyamide metal laminate. The varnish is a solution obtained by polymerizing the aforementioned specific diamine and tetracarboxylic dianhydride in a solvent.

The application directly onto a metal foil may be performed by conventional methods using a die coater, a comma coater, a roll coater, a gravure coater, a curtain coater, a spray coater or the like. These coaters may be selected as appropriate in accordance with the coating thickness, viscosity of the varnish, and others.

The coated varnish may be dried and cured using a conventional oven for heating and drying. The heating atmosphere may be selected from the air, inert gas such as nitrogen and argon, and others. The heating temperature may be selected as appropriate in accordance with the boiling point of the solvent, but is preferably in the range of from 60° C. to 600° C. The drying time may be also selected as appropriate in accordance with the thickness, the concentration, and the kind of the solvent, but is desirably in the range of from 0.05 minute to 500 minutes.

According to the present invention, a polyimide metal laminate having excellent heat resistance can be obtained. Therefore, the polyimide metal laminate of the present invention is suitably used particularly for a suspension of hard disk drives.

### EXAMPLES

The present invention will be further described in detail with reference to examples and comparative examples. In the examples, a series of properties are evaluated by the following methods.

[Evaluation of Expansion and Deformation by Heating]

A polyimide resin layer is formed on a metal foil to prepare a polyimide metal laminate. The laminate is left standing in an inert oven (manufactured by ESPEC Corp.) at an atmospheric temperature of 350° C. for 60 minutes. The laminate is taken out of the oven and cooled to room temperature. The metal foil disposed on one side of the laminate is removed by etching, and the surface of the polyimide resin is inspected whether there is expansion or peeling off (whether the polyimide resin is deformed) by a stereoscopic microscope with a magnification of 100 times. When a peeling off is observed, the size thereof is measured. The laminate having a peeling off of 100 μm or more is evaluated as unacceptable, and the laminate having no peeling off of 100 μm or more is evaluated as acceptable.

[Evaluation of Peel Strength]

Peel strength is evaluated by the method in accordance with IPC-TM-650, TypeA Sec2.4.9. The peel strength (delamination strength) after heating is evaluated after preparing a test specimen for peel strength; leaving the test specimen standing in an inert oven heated at 350° C. for 60 minutes; and cooling the test specimen to room temperature.

[Evaluation of Storage Elastic Modulus]

Storage elastic modulus at tensile-mode is measured with RSA-2 manufactured by Reometrics Inc. The temperature elevation speed is 3° C. per minute, the measurement temperature range is from 100° C. to 400° C., and the frequency applied is 1 Hz. The storage elastic moduli at 300° C. and 350° C. are calculated by viscoelastic analysis.

[Evaluation of Glass Transition Temperature]

Glass transition temperature at tensile-mode is evaluated with TMA-4000 manufactured by Bruker AXS Co., Ltd. The measurement is conducted at a temperature elevation speed of 10° C. per minute and in a temperature range of from 100° C. to 400° C. The inflexion point of the elongation curve versus temperature is determined as the glass transition temperature.

The abbreviations for the solvents, acid dianhydrides, and diamines used in Examples and others are as follows
DMAc: N,N′-dimethylacetoamide,
NMP: N-methyl-2-pyrrolidone,
PPD: p-phenylenediamine,
ODA: 4,4′-diaminodiphenyl ether,
m-BP: 4,4′-bis(3-aminophenoxy)biphenyl,
APB: 1,3-bis(3-aminophenoxy)benzene,
APB5: 1,3-bis(3-(3-aminophenoxy)phenoxy)benzene,
DABP: 3,3′-diaminobenzophenone,
TPE: 1,3-bis(4-aminophenoxy)benzene,
p-BAPP: 2,2-bis[4-(4-aminophenoxy)phenyl]propane,
BTDA: 3,3′,4,4′-benzophenone tetracarboxylic dianhydride,
PMDA: pyromellitic dianhydride, and
BPDA: 3,3′,4,4′-biphenyl tetracarboxylic dianhydride.

### Synthesis Example 1

### Synthesis of Thermoplastic Polyimide Precursor

The tetracarboxylic dianhydrides and diamines described in Table 1 were weighed and dissolved in 630 g of DMAc in a 1000 ml separable flask under a nitrogen gas stream. After that, polymerization was continued for 6 hours while stirring to obtain thermoplastic polyimide precursor varnishes A to D.

TABLE 1

| Charged amount (mol) | A | B | C | D |
|---|---|---|---|---|
| BTDA | 0.02 | 0.04 | 0.04 | 0.02 |
| BPDA | 0.11 | 0.10 | 0.20 | 0.22 |
| PMDA | 0.11 | 0.10 | | |
| p-BAPP | | | 0.15 | 0.25 |
| APB | 0.02 | 0.05 | 0.10 | |
| APB5 | | | | |
| m-BP | 0.23 | 0.20 | | |
| Glass transition temperature (° C.) | 241 | 236 | 203 | 250 |

### Synthesis Example 2

### Synthesis of Thermoplastic Polyimide Precursor

The tetracarboxylic dianhydrides and diamines described in Table 2 were weighed and dissolved in 630 g of DMAc in a 1000 ml separable flask under a nitrogen gas stream. After that, polymerization was continued for 6 hours while stirring to obtain thermoplastic polyimide precursor varnishes E to I.

TABLE 2

| Charged amount (mol) | E | F | G | H | I |
|---|---|---|---|---|---|
| BTDA | | 0.24 | | 0.11 | 0.03 |
| BPDA | 0.12 | | 0.24 | 0.06 | 0.21 |
| PMDA | 0.12 | | | 0.07 | |
| p-BAPP | | | 0.25 | | |
| TPE | | | | | 0.25 |
| APB | | 0.25 | | 0.12 | |
| m-BP | 0.25 | | | 0.13 | |
| Glass transition | 245 | 195 | 252 | 220 | 260 |
| temperature (° C.) | | | | | |

### Synthesis Example 3

### Synthesis of Non-Thermoplastic Polyimide Precursor

As the diamines, 7.7 mols of PPD, 1.15 mols of ODA, 1.15 mols of m-BP were weighed. As the dianhydrides, 5.4 mols of BPDA and of 4.45 mols PMDA were weighed. They were dissolved in a mixed solvent of DMAc and NMP, the ratio of which was such that the former was 23 wt % and the latter was 77 wt %. The viscosity of the resulting polyamic acid varnish as measured with an E-type viscometer at 25° C. was 30,000 cps, which was adequate for coating.

### Example 1

### Evaluation of Polyimide Single Layer

A commercially available stainless steel foil (manufactured by Nippon Steel Corporation, trade name: SUS304H-TA, thickness: 20 μm) was coated with the polyamic acid varnishes A to D prepared in Synthesis Example 1, respectively, and dried to form a thermoplastic polyimide layer. The thickness of the polyimide layer after coating and drying was 13 μm. Note that, the coating was dried in a stepwise manner at 100° C., 150° C., 200° C., 250° C., and 300° C., each for 5 minutes, successively. The stainless steel foil was removed by etching to obtain polyimide single layer films A′ to D′. Measurement of dynamic viscoelasticity was performed in accordance with the aforementioned method, and storage elastic moduli at 300° C. and 350° C. were calculated. The results are shown in Table 3.

TABLE 3

| | A′ | B′ | C′ | D′ |
|---|---|---|---|---|
| Storage elastic modulus | 6 × 10⁷ | 9 × 10⁷ | 7 × 10⁷ | 8 × 10⁷ |
| at 300° C. (Pa) | | | | |
| Storage elastic modulus | 3 × 10⁷ | 7 × 10⁷ | 5 × 10⁷ | 5 × 10⁷ |
| at 350° C. (Pa) | | | | |

### Example 2

### Preparation of Polyimide Metal Laminate

A commercially available copper alloy foil (manufactured by Olin Inc., trade name: C7025, thickness: 18 μm) was coated with the polyamic acid varnishes A to D prepared in Synthesis Example 1, respectively, and dried to form thermoplastic polyimide layers; the obtained layers were coated with the polyamic acid varnish prepared in Synthesis Example 3 and dried to form a non-thermoplastic polyimide; and the obtained layers were further coated with the polyamic acid varnishes A to D prepared in Synthesis Example 1, respectively, and dried to obtain polyimide metal laminates having a metal foil on one side. Subsequently, a commercially available stainless steel foil (manufactured by Nippon Steel Corp., trade name: SUS304H-TA, thickness: 20 μm) was laminated on the laminates and bonded by hot pressing to obtain polyimide metal laminates A″ to D″. In the coating process, each polyamic acid varnish prepared in Synthesis Example 1 was coated with a reverse roll coater, and the polyamic acid vanish prepared in Synthesis Example 3 was coated with a die coater. The thickness of the polyimide layers after coating and drying were 2 μm and 11 μm, respectively. Note that, each coating was dried in a stepwise manner at 100° C., 150° C., 200° C., 250° C., 300° C. and 350° C., each for 5 minutes, successively. The conditions for hot pressing were 300° C., 50 kgf/cm², and 1.5 hours.

<Evaluation of Polyimide Metal Laminate>

Expansion and deformation by heating, peel strength (delamination strength), and peel strength (delamination strength) after heating at 350° C. for 60 minutes of the obtained polyimide metal laminates were evaluated in accordance with the method as described above. The results are shown in Table 4.

TABLE 4

| | A″ | B″ | C″ | D″ |
|---|---|---|---|---|
| Expansion and | Acceptable | Acceptable | Acceptable | Acceptable |
| deformation by | | | | |
| heating | | | | |
| Peel strength | 1.3 | 1.1 | 1.2 | 1.2 |
| (kN/m) | | | | |
| Peel strength | 1.7 | 1.5 | 1.3 | 1.6 |
| after heating | | | | |
| (kN/m) | | | | |

### Example 3

### Preparation of Double-Faced Adhesive Sheet

Both sides of a commercially available polyimide film (manufactured by Kaneka Corp., trade name: Apical™ 12.5NPI, thickness: 12.5 μm) were coated with the polyamic acid varnishes A to D prepared in Synthesis Example 1, respectively, and dried to form a non-thermoplastic polyimide layer, thereby obtaining double-faced adhesive sheets. A reverse roll coater was used for the application of the thermoplastic polyamic acid varnishes prepared in Synthesis Example 1. The total thickness of the polyimide layers after coating and drying was 18 μm. Note that, each coating was dried in a stepwise manner at 100° C., 150° C., 200° C., 250° C., and 300° C., each for 5 minutes, successively.

<Hot Pressing>

A copper alloy foil (manufactured by Olin Inc., trade name: C7025 (custom-order brand), thickness: 18 μm) and a stainless steel foil (manufactured by Nippon Steel Corp., trade name: SUS304H-TA, thickness: 20 μm) were used as the metal. The double-faced adhesive sheets with the C7025 foil and SUS304H-TA foil laminated on respective sides thereof was sandwiched between cushion materials (manufactured by KINYOSHA CO., LTD., trade name: KINYO BOARD F200), and hot-pressed with a hot-pressing machine under the conditions of 250° C. and 70 kg/cm² for 60 minutes to obtain polyimide metal laminates A″′ to D″′ consisting of the five layers of SUS304H-TA/thermoplastic polyimide/non-thermoplastic polyimide/thermoplastic polyimide/C7025.

<Evaluation of Polyimide Metal Laminate>

Expansion and deformation by heating, peel strength, and peel strength after heating at 350° C. for 60 minutes of the obtained polyimide metal laminates were evaluated in accordance with the methods as described above. The results are shown in Table 5. When the polyimide metal laminates prepared in Examples 2 and 3 were used for processing of a suspension for hard disk drives, a suspension with high productivity and high quality was produced, i.e., the polyimide had a favorable heat resistance and no peeling off of the wiring occurred after curing of the covering material.

TABLE 5

| | A″′ | B″′ | C″′ | D″′ |
|---|---|---|---|---|
| Expansion and | Acceptable | Acceptable | Acceptable | Acceptable |
| deformation by | | | | |
| heating | | | | |
| Peel strength | 1.5 | 1.3 | 1.5 | 1.5 |
| (kN/m) | | | | |
| Peel strength | 1.9 | 1.7 | 1.8 | 1.9 |
| after heating | | | | |
| (kN/m) | | | | |

### Comparative Example 1

### Evaluation of Polyimide Single Layer Film

A commercially available stainless steel foil (manufactured by Nippon Steel Corp., trade name: SUS304H-TA, thickness: 20 μm) was coated with the polyamic acid varnishes E to I prepared in Synthesis Example 2, respectively, and dried to form thermoplastic polyimide layers. The thickness of the polyimide layers after coating and drying was 13 μm. Note that, the coating was dried in a stepwise manner at 100° C., 150° C., 200° C., 250° C., and 300° C., each for 5 minutes, successively. The stainless steel foil was removed by etching to obtain polyimide single layer films E′ to 1′. Measurement of dynamic viscoelasticity was performed in accordance with the aforementioned method, and storage elastic moduli at 300° C. and 350° C. were calculated. The results are shown in Table 6.

TABLE 6

| | E′ | F′ | G′ | H′ | I′ |
|---|---|---|---|---|---|
| Storage elastic modulus | 2 × 10⁷ | 7 × 10⁸ | 2 × 10⁷ | 8 × 10⁸ | 2 × 10⁸ |
| at 300° C. (Pa) | | | | | |
| Storage elastic modulus | 3 × 10⁵ | 5 × 10⁸ | 5 × 10⁶ | 3 × 10⁸ | 9 × 10⁷ |
| at 350° C. (Pa) | | | | | |

### Comparative Example 2

### Preparation and Evaluation of Polyimide Metal Laminate

Polyimide metal laminates E″ to I″ were prepared and evaluated in the same manner as in Example 2, except that the thermoplastic polyimide precursors E to I prepared in Synthesis Example 2 were used as the thermoplastic polyimide. The results are shown in Table 7.

TABLE 7

| | E″ | F″ | G″ | H″ | I″ |
|---|---|---|---|---|---|
| Expansion and deformation by heating | Unacceptable | Acceptable | Unacceple | Acceptable | Acceptable |
| Peel strength (kN/m) | 1.5 | 1.2 | 1.4 | 0.7 | 0.8 |
| Peel strength after heating (kN/m) | 2.1 | 0.5 | 1.9 | 0.7 | 1.3 |

### Comparative Example 3

### Preparation and Evaluation of Polyimide Metal Laminate

Polyimide metal laminates E″′ to I″′ were prepared and evaluated in the same manner as in Example 3, except that the thermoplastic polyimide precursors E to I prepared in Synthesis Example 2 were used as the thermoplastic polyimide. The results are shown in Table 8.

TABLE 8

| | E′″ | F′″ | G′″ | H′″ | I′″ |
|---|---|---|---|---|---|
| Expansion and deformation by heating | Unacceptable | Acceptable | Unacceptable | Acceptable | Acceptable |
| Peel strength (kN/m) | 1.8 | 1.5 | 1.6 | 0.9 | 0.9 |
| Peel strength after heating (kN/m) | 2.1 | 0.7 | 2.1 | 0.7 | 1.3 |

When the polyimide metal laminates prepared in Comparative Examples 2 and 3 were used for processing of a suspension for hard disk drives, the polyimide had poor heat resistance and peeling off of the wiring occurred after curing of the covering material. Therefore, a suspension having desired properties could not be produced.

### INDUSTRIAL APPLICABILITY

The present invention provides a laminate capable of undergoing ultra fine processing. This laminate can be applied to a product with ultra-fine patterns such as a suspension material for hard disk drives.

1. A polyimide metal laminate comprising a polyimide resin having a copper foil and a stainless steel foil formed on respective sides of the polyimide resin, or a polyimide resin having two stainless steel foils formed on both sides of the polyimide resin, the polyimide metal laminate having:
a peel strength of 1.0 kN/m or more between the polyimide resin and the stainless steel foil or copper foil;
a peel strength of 1.0 kN/m or more between the polyimide resin and the stainless steel foil or copper foil after the polyimide metal laminate has been subjected to a heat treatment at 350° C. for 60 minutes; and
no deformation after the polyimide metal laminate has been subjected to the heat treatment at 350° C. for 60 minutes.

2. The polyimide metal laminate according to claim 1, wherein the polyimide resin in contact with the stainless steel foil or copper foil has a glass transition temperature of 180° C. or higher; a storage elastic modulus at 300° C. of from 1×10⁷ Pa to 1×10⁸ Pa; and a storage elastic modulus at 350° C. of from 2×10⁷ Pa to 2×10⁸ Pa.

3. The polyimide metal laminate according to claim 1, wherein
the polyimide resin in contact with the stainless steel foil or copper foil is a polyimide obtained by reacting a diamine and a tetracarboxylic dianhydride,
the tetracarboxylic dianhydride used for the reaction being a combination of 3,3′,4,4′-benzophenone tetracarboxylic dianhydride and at least one tetracarboxylic dianhydride selected from pyromellitic dianhydride and 3,3′4,4′-biphenyltetracarboxylic dianhydride,
the amount of the 3,3′,4,4′-benzophenone tetracarboxylic dianhydride being 8 mol % or more and 20 mol % or less of a total amount of the tetracarboxylic dianhydrides used for the reaction, and wherein
the diamine used for the reaction contains at least one diamine selected from 1,3-bis(3-aminophenoxy)benzene, 4,4′-bis(3-aminophenoxy)biphenyl, 1,3-bis(3-(3-aminophenoxy)phenoxy)benzene, and 2,2-bis[4-(4-aminophenoxy)phenyl]propane.

4. A suspension for hard disk drives, wherein the suspension is prepared from the polyimide metal laminate according to claim 1.

5. A suspension for hard disk drives, wherein the suspension is prepared from the polyimide metal laminate according to claim 2.

6. A suspension for hard disk drives, wherein the suspension is prepared from the polyimide metal laminate according to claim 3.
